(19) United States
(12) Patent Application Publication
(10) Pub. No.: US 2026/0367783 A1
(43) Pub. Date: Nov. 19, 2026

(54) FLEXIBLE DATA PLACEMENT AND STORAGE AGGREGATION OPTIONS THROUGH NON-INVASIVE MODULE ADDITION

(71) Applicant: Micron Technology, Inc., Boise, ID (US)

(72) Inventor: Luca Bert, Bologna (BO) (IT)

(21) Appl. No.: 19/208,230

(22) Filed: May 14, 2025

(51) Int. Cl. G06F 3/06

(52) U.S. Cl. CPC G06F 3/0604; G06F 3/0632; G06F 3/0643; G06F 3/0679

(57) ABSTRACT

A method facilitates adoption of advanced storage technologies through non-invasive module addition to the operating system storage stack. The method includes intercepting write requests from storage abstraction layers, performing back queries to determine data classifications, and tagging requests with placement information. A helper routine comprising functional and presentation layers is positioned between the virtual file system and block I/O driver, enabling intelligent data placement without requiring modifications to existing file systems or applications. During system initialization, the method detects available storage features and configures appropriate classification rules. For write operations, the method analyzes requests, determines classifications through direct querying or inference, and assigns optimized storage destinations based on data characteristics. This approach enables immediate utilization of technologies like Flexible Data Placement (FDP), Zoned Namespaces (ZNS), and heterogeneous cell-type storage while maintaining compatibility with established software ecosystems.

### BACKGROUND

Computing systems commonly rely on various forms of storage devices to maintain persistent data. Traditional storage architectures use a layered approach where applications interact with file systems or databases, which in turn communicate with block I/O (input/output) drivers and device drivers before ultimately accessing physical storage devices. These layers provide necessary abstractions that allow applications to store and retrieve data without concern for the underlying physical storage characteristics.

As computing needs have evolved, storage requirements have grown increasingly complex. Today’s systems must handle enormous data volumes while maintaining performance, reliability, and cost-effectiveness. Different types of data often have distinct storage requirements—some data might require frequent, rapid access while other data may be accessed rarely but require long-term persistence.

Conventional storage systems typically treat all data uniformly, placing it on storage media without consideration for the data’s specific characteristics or usage patterns. This one-size-fits-all approach can lead to suboptimal performance, reduced device lifespan, and inefficient capacity utilization. While storage device technologies have advanced to address these challenges, integrating these advancements into existing software ecosystems often requires extensive modifications to established components such as file systems, databases, and applications.

This disclosure describes methods and systems that enable intelligent data placement across various storage technologies without requiring invasive modifications to existing software components.

### BRIEF DESCRIPTION OF THE DRAWINGS

FIG. 1 is a block diagram illustrating a computing system architecture according to some of the disclosed embodiments.

FIG. 2 is a flow diagram illustrating a method for performing back queries to determine data mapping for data separation and aggregation according to some of the disclosed embodiments.

FIG. 3 is a flow diagram illustrating a method for performing back queries specifically for file system data classification according to some of the disclosed embodiments.

FIG. 4 is a sequence diagram illustrating the interaction between components during a write operation with back query according to some of the disclosed embodiments.

FIG. 5 is a flow diagram illustrating a method for initializing the helper routine during system boot according to some of the disclosed embodiments.

FIG. 6 is a flow diagram illustrating a method for handling I/O requests with data classification according to some of the disclosed embodiments.

FIG. 7 is a block diagram of a computing device according to some embodiments of the disclosure.

### DETAILED DESCRIPTION

Storage technologies such as Flexible Data Placement (FDP), Zoned Namespace (ZNS), and heterogeneous cell-type SSDs (SLC/TLC/QLC) require data placement decisions to be made at the time of writing. However, the components that have the necessary context to make intelligent placement decisions (e.g., file systems, databases, key-value stores) are typically separated from the storage hardware by several abstraction layers. Modifying these components to directly support advanced storage features requires extensive code changes, regression testing, and recertification—a process that can take months or years to complete. This creates a technical barrier where storage hardware supports capabilities that software cannot effectively utilize without significant restructuring of the I/O stack.

The technology described in this disclosure overcomes these technical constraints by introducing a non-invasive helper routine that integrates into the existing I/O stack without requiring modifications to higher-level components. This solution includes a functional layer that intercepts write requests, performs back queries to determine data characteristics, and tags the requests with appropriate placement information. The solution further includes a presentation layer that maps these tagged requests to specific storage locations optimized for the data type. By implementing these functions as, for example, a port mapper (in the Linux® operating system) or filter/function driver (in the Windows® operating system) positioned between the virtual file system and block I/O driver, the solution enables transparent intelligence in the storage stack. This approach allows existing applications and file systems to immediately benefit from advanced storage features without code modifications, solving the technical problem of feature adoption while maintaining compatibility with established software ecosystems.

In some implementations, the techniques described herein relate to a method including: intercepting, by a processor, a write request from a storage abstraction layer; identifying, by the processor, an originator type of the write request; performing, by the processor, a back query to the originator to determine a classification of data associated with the write request; tagging, by the processor, the write request with placement information based on the determined classification; forwarding, by the processor, the tagged write request to a presentation layer; and directing, by the presentation layer, the write request to a location on a storage device based on the placement information.

In some implementations, the techniques described herein relate to a method, wherein performing the back query includes extracting logical block address (LBA) information from the write request, accessing an allocation table of a file system when the originator type is a file system, and determining whether the LBA corresponds to a metadata region or a user data region.

In some implementations, the techniques described herein relate to a method, wherein the placement information includes at least one Reclaim Unit Handle (RUH) for a storage device supporting Flexible Data Placement (FDP) or a Zone identifier for a storage device supporting Zoned Namespace (ZNS).

In some implementations, the techniques described herein relate to a method, wherein performing the back query includes accessing an internal structure of a key-value store when the originator type is a key-value store, and determining whether the data corresponds to a key or a value.

In some implementations, the techniques described herein relate to a method, wherein performing the back query includes accessing an internal structure of a database when the originator type is a database, and determining whether the data corresponds to a sorted Sequence table (SST), a write-ahead log, or other database-specific structure.

In some implementations, the techniques described herein relate to a method, further including determining that a back query is not available, determining whether a classification can be inferred based on characteristics of the write request, and applying classification rules or using a default classification.

In some implementations, the techniques described herein relate to a method, further including initializing a helper routine during a system boot process, the initializing including detecting storage devices connected to a computing system, determining whether the connected storage devices support advanced storage features, and loading the helper routine when advanced storage features are supported.

In some implementations, the techniques described herein relate to a method including: detecting, by a processor, storage devices connected to a computing system; determining, by the processor, whether the connected storage devices support advanced storage features; loading, by the processor, a helper routine when advanced storage features are supported; configuring, by the processor, data classification rules for a functional layer of the helper routine; initializing, by the processor, a presentation layer of the helper routine; and registering, by the processor, the helper routine in an I/O path of an operating system.

In some implementations, the techniques described herein relate to a method, wherein determining whether the connected storage devices support advanced storage features includes querying each storage device for support of at least one of Flexible Data Placement (FDP), Zoned Namespace (ZNS), or heterogeneous cell type partitions.

In some implementations, the techniques described herein relate to a method, wherein configuring data classification rules includes loading rule sets from persistent storage, applying default rules based on detected storage devices, or dynamically generating rules based on system characteristics.

In some implementations, the techniques described herein relate to a method, wherein initializing the presentation layer includes setting up device mapping tables and creating configurations for mapping logical addresses to physical devices.

In some implementations, the techniques described herein relate to a method, wherein registering the helper routine includes positioning the functional layer between a virtual file system and a block I/O driver, and positioning the presentation layer between the functional layer and device-specific drivers.

In some implementations, the techniques described herein relate to a method, further including proceeding with a regular I/O stack when the connected storage devices do not support advanced storage features.

In some implementations, the techniques described herein relate to a method including: receiving, by a processor, an I/O request at a functional layer in a storage stack; determining, by the processor, whether the I/O request is a read operation or a write operation; passing, by the processor, the I/O request directly to a presentation layer when the I/O request is a read operation; analyzing, by the processor, the I/O request when the I/O request is a write operation; determining, by the processor, a classification for data associated with the write operation; and assigning, by the processor, a storage destination for the data based on the determined classification.

In some implementations, the techniques described herein relate to a method, wherein determining a classification includes determining whether a back query is available for an originator of the write operation, performing the back query when available, and receiving a data classification response.

In some implementations, the techniques described herein relate to a method, wherein determining a classification includes determining that a back query is not available, determining whether classification can be inferred based on characteristics of the write operation, and applying classification rules when inference is possible.

In some implementations, the techniques described herein relate to a method, wherein determining a classification includes determining that classification cannot be inferred and applying a default classification to the data.

In some implementations, the techniques described herein relate to a method, wherein assigning a storage destination includes mapping the classification to a specific reclaim unit, zone, or partition optimized for that type of data.

In some implementations, the techniques described herein relate to a method, further including tagging the write operation with placement information corresponding to the assigned storage destination.

In some implementations, the techniques described herein relate to a method, further including forwarding the I/O request with assigned storage destination information to the presentation layer for mapping to physical storage locations.

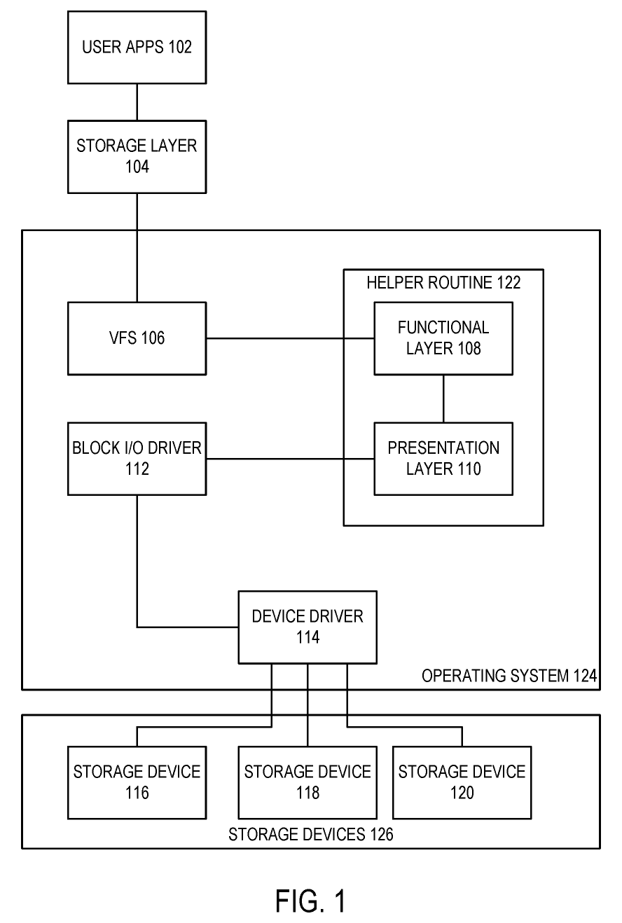

FIG. 1 is a block diagram illustrating a computing system architecture according to some of the disclosed embodiments.

In the illustrated embodiment, a storage system architecture includes multiple layers arranged in a hierarchical structure. At the top level, user applications 102 interact with the system by issuing read and write requests to access stored data. These applications may include any software that requires persistent data storage, such as database applications, file browsers, media applications, or enterprise software. The user applications 102 do not directly access storage devices but instead communicate with the next layer in the hierarchy.

User applications 102 interface with a storage abstraction layer 104, which may comprise a file system, database manager, key-value store, or similar technology. This layer provides a structured interface for applications to store and retrieve data through logical constructs such as files, tables, key-value pairs, etc. The storage abstraction layer 104 handles the organization of data and provides APIs (application programming interfaces) that abstract away the complexities of physical storage management. For example, a file system component might translate file operations into block-level operations, while a database manager might handle SQL (structured query language) queries by mapping them to appropriate storage operations.

The storage abstraction layer 104 communicates with the virtual file system 106, which is part of the operating system 124. The virtual file system 106 provides a unified interface to multiple file system types and serves as a bridge between the user-space software and the kernel-space storage stack. It standardizes operations such as opening, reading, writing, and closing files across different storage technologies and file system implementations. This abstraction allows applications to interact with various storage types without needing specialized code for each storage technology.

Within the operating system 124, a helper routine 122 is implemented to facilitate advanced data placement and aggregation. The helper routine 122 consists of two primary components: the functional layer 108 and the presentation layer 110. These components work together to enable intelligent data placement without requiring modifications to existing file systems or applications. This non-invasive approach is one innovation of the architecture, allowing adoption of advanced storage technologies without disrupting established software ecosystems.

The functional layer 108 receives I/O requests from the virtual file system 106 and performs back queries to determine the nature of the data being written. For write operations, the functional layer 108 examines the request, communicates with the originating component (such as the file system) to classify the data, and then tags the request with appropriate classification information. This classification might identify data as metadata or user data, as keys or values in a key-value store, or according to other application-specific criteria. By understanding the characteristics of the data, the system can make intelligent decisions about optimal placement. Details of these operations are provided in the following flow diagrams and are not repeated herein.

After the functional layer 108 has classified and tagged the data, the presentation layer 110 receives the tagged requests. The presentation layer 110 is responsible for mapping the logical storage view presented to higher layers to the physical storage devices. It determines which storage device and which specific region within that device should receive the data based on the classification tags. This layer can aggregate multiple physical storage devices to appear as a single logical storage entity to the upper layers, effectively hiding the complexity of the underlying storage infrastructure.

The presentation layer 110 forwards the processed requests to the block I/O driver 112, which is another component of the operating system 124. The block I/O driver 112 handles block-level operations and provides a standardized interface for sending commands to various storage devices. It manages request queuing, scheduling, and completion notification. This standardization simplifies the integration of new storage technologies into the system by providing a consistent interface regardless of the underlying hardware.

From the block I/O driver 112, requests are passed to the device driver 114, which is the lowest software layer in the operating system 124. The device driver 114 translates generic block I/O commands into device-specific commands understood by the particular storage hardware installed in the system. This translation includes handling specific command formats, addressing modes, and communication protocols required by each storage device. The device driver layer enables the operating system to communicate with a wide range of storage hardware through standardized interfaces.

The device driver 114 communicates directly with the physical storage devices 126. In the illustrated embodiment, the storage devices include storage device 116, which supports Reclaim Unit Handles (RUH) for flexible data placement; storage device 118, which implements Zoned Namespace (ZNS) technology; and storage device 120, which features partitions with different cell types (SLC and QLC). Each of these storage technologies offers specific advantages for certain types of data and workloads. The specific types, numbers, and combinations of storage devices is not limiting.

In one example, storage device 116 with RUH support allows data to be placed in specific reclaim units, enabling fine-grained control over garbage collection and write amplification. This can significantly improve performance and endurance by grouping data with similar lifetimes or update frequencies together. RUH technology allows the system to direct specific data types to designated reclaim units, minimizing unnecessary data movement during garbage collection operations.

In one example, storage device 118 with ZNS support requires data to be written sequentially within zones, which can reduce write amplification and improve performance for certain workloads. ZNS devices place the responsibility of data placement on the host rather than the device, enabling more intelligent data management. This approach is particularly beneficial for workloads with sequential write patterns, such as logging or database write-ahead logs.

In one example, storage device 120 features partitions with different cell types, specifically Single-Level Cell (SLC) and Quad-Level Cell (QLC) flash memory. SLC offers higher performance and endurance but at higher cost per capacity, while QLC provides greater capacity at lower cost but with reduced performance and endurance. By directing different types of data to the appropriate partition, the system can optimize for both performance and capacity. For example, frequently updated metadata might be directed to SLC partitions, while rarely accessed archive data might go to QLC partitions.

The helper routine 122, comprising the functional layer 108 and presentation layer 110 enables intelligent data placement and aggregation across diverse storage technologies without requiring modifications to existing applications or file systems. This non-invasive approach facilitates the adoption of advanced storage features while maintaining compatibility with existing software ecosystems. The following flow diagrams describe the operation of the helper routine 122 and other components of the illustrated system.

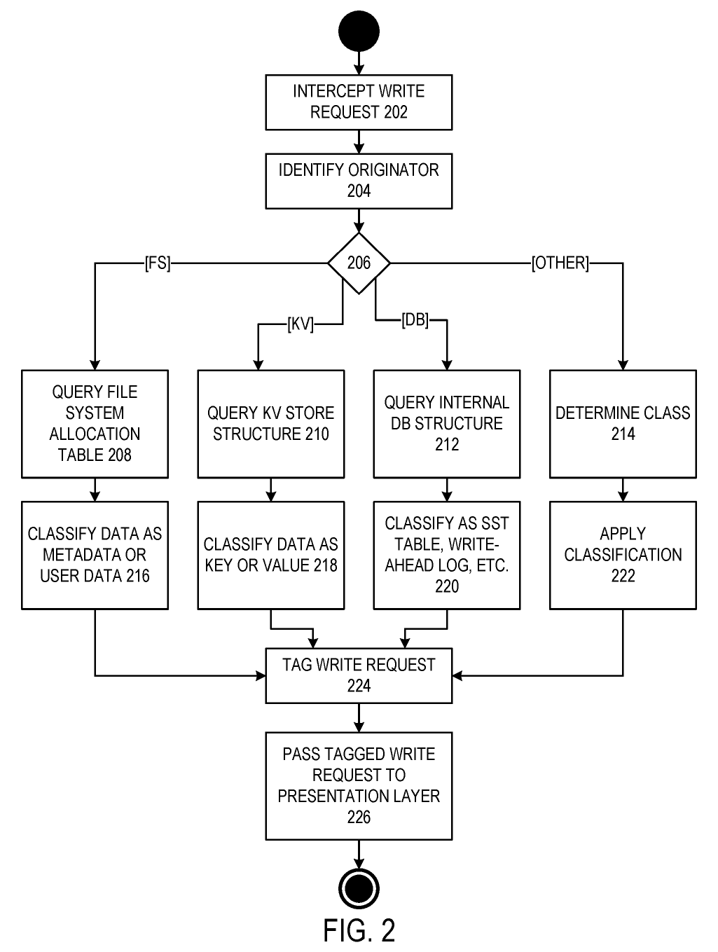

FIG. 2 is a flow diagram illustrating a method for performing back queries to determine data mapping for data separation and aggregation according to some of the disclosed embodiments.

The method begins at step 202, where the method intercepts a write request coming from an upper layer in the storage stack. This interception occurs within the functional layer of the helper routine, which is positioned between the virtual file system and the block I/O driver in the operating system’s storage stack. In some implementations, the interception mechanism leverages existing hook points within the operating system kernel, allowing the functional layer to examine and potentially modify I/O requests without requiring changes to either the originating applications or the underlying storage subsystem.

In step 204, the method identifies the originator of the write request. The originator refers to the component that generated the write request, such as a file system, key-value store, database, or other storage abstraction layer. This identification process may involve examining metadata associated with the request, such as process identifiers, file handles, or other contextual information provided by the operating system. In some implementations, the method maintains a registry of known originators and their corresponding query interfaces, allowing it to dynamically adapt its behavior based on the type of originator detected.

In step 206, the method branches based on the type of originator identified in the previous step. This step enables tailored interactions with different types of storage abstractions. The method follows one of four main paths depending on whether the originator is a file system, a key-value store, a database, or some other type of storage abstraction. This branching structure allows the method to handle a wide variety of storage systems while maintaining a consistent approach to data classification. As such, the specific number of paths is not limiting and provided merely as an example of one configuration.

If the originator is a file system, the method proceeds to step 208, where it queries the file system’s allocation table. The allocation table contains information about how logical blocks are mapped to files and file metadata. By examining this table, the method can determine whether a given block belongs to file data or filesystem metadata. In some implementations, this query might involve accessing in-memory data structures maintained by the file system, such as inodes, extents, or other metadata structures. The method performs this query using standard kernel interfaces provided by the file system, ensuring compatibility with various file system implementations without requiring modifications to their code.

If the originator is a key-value store, the method proceeds to step 210, where it queries the key-value store’s internal structure. This query enables the method to determine whether the write operation pertains to a key or a value within the store. Keys typically have different characteristics than values—they are smaller, accessed more frequently, and often have different durability requirements. In some implementations, the query might involve accessing in-memory hash tables, B-trees, or other data structures used by the key-value store to organize its data. The method leverages standard interfaces or extension points provided by the key-value store to perform these queries without requiring modifications to its core code.

If the originator is a database, the method proceeds to step 212, where it queries the database’s internal structure. This query allows the method to identify specific database components being written, such as sorted string tables (SSTs), write-ahead logs, or other database-specific constructs. Different database components often have distinct access patterns and durability requirements, making this classification valuable for optimizing storage performance. In some implementations, the query might involve accessing the database’s catalog, transaction logs, or buffer pools to determine the role of the data being written. The method utilizes available database interfaces or extension mechanisms to perform these queries without requiring changes to the database engine itself.

If the originator is some other type of storage abstraction, the method proceeds to step 214, where it determines the classification based on configurable rules. These rules might consider factors such as the size of the write request, the logical address range being written, access patterns observed for this address range, or other heuristics. In some implementations, these rules can be specified in a configuration file, allowing system administrators to customize the classification behavior based on their specific workloads and storage technologies. This approach provides flexibility for handling storage abstractions that don’t fall into the previous categories or for which specific query interfaces haven’t been implemented.

Following the classification determination, the method proceeds to one of four classification steps based on the results of the query, as illustrated.

If the query in step 208 determined the data’s role within a file system, the method proceeds to step 216, where it classifies the data as either metadata or user data. Metadata includes directory structures, file attributes, journaling information, and other structural elements of the file system. User data refers to the actual contents of files stored within the file system. This classification is valuable because metadata and user data typically have different access patterns, update frequencies, and performance requirements.

If the query in step 210 determined the data’s role within a key-value store, the method proceeds to step 218, where it classifies the data as either a key or a value. Keys are typically accessed more frequently than values and may benefit from placement in higher-performance storage regions. Values may vary widely in size and access patterns, with some being accessed frequently alongside their keys and others being accessed rarely. This classification enables optimized placement strategies for key-value store workloads.

If the query in step 212 determined the data’s role within a database, the method proceeds to step 220, where it classifies the data according to database-specific constructs. This might include classifications such as SST tables of different levels, write-ahead logs, transaction journals, or database metadata. Different components of a database have distinct performance requirements—for example, write-ahead logs require low-latency writes but might not need high read performance, while frequently accessed index structures benefit from high read performance.

If the classification was determined based on configurable rules in step 214, the method proceeds to step 222, where it applies the resulting classification. This might involve categorizing the data based on size, access frequency, or other criteria specified in the configuration. This approach provides flexibility for handling a wide variety of storage abstractions and workloads, even those not specifically designed with advanced storage features in mind.

After classification, all paths converge at step 224, where the method tags the write request with the appropriate Reclaim Unit Handle (RUH), zone information, or other tag (depending on implementation). This tag indicates where the data should be placed on the storage device based on its classification. For example, metadata might be assigned to a high-performance RUH or zone, while rarely accessed data might be assigned to a high-capacity but lower-performance region. The tagging process modifies the write command structure to include the RUH or zone information, utilizing fields that are typically reserved or unused in standard write commands.

In step 226, the method passes the tagged write request to the presentation layer. The presentation layer is responsible for mapping the logical view of storage to the physical devices and will use the tag information to direct the write to the appropriate storage location. This handoff represents a transition point in the I/O path, where the classification information determined by the functional layer is used to influence the physical placement of data.

The method then ends, completing the back query and classification process for this write request. The entire process is repeated for each write request intercepted by the functional layer, enabling consistent application of data placement policies across the storage subsystem.

By performing back queries to determine the nature of data being written, this method enables intelligent data placement without requiring modifications to existing applications or file systems. This non-invasive approach facilitates the adoption of advanced storage technologies like FDP and ZNS, allowing systems to benefit from improved performance, endurance, and capacity utilization while maintaining compatibility with existing software ecosystems.

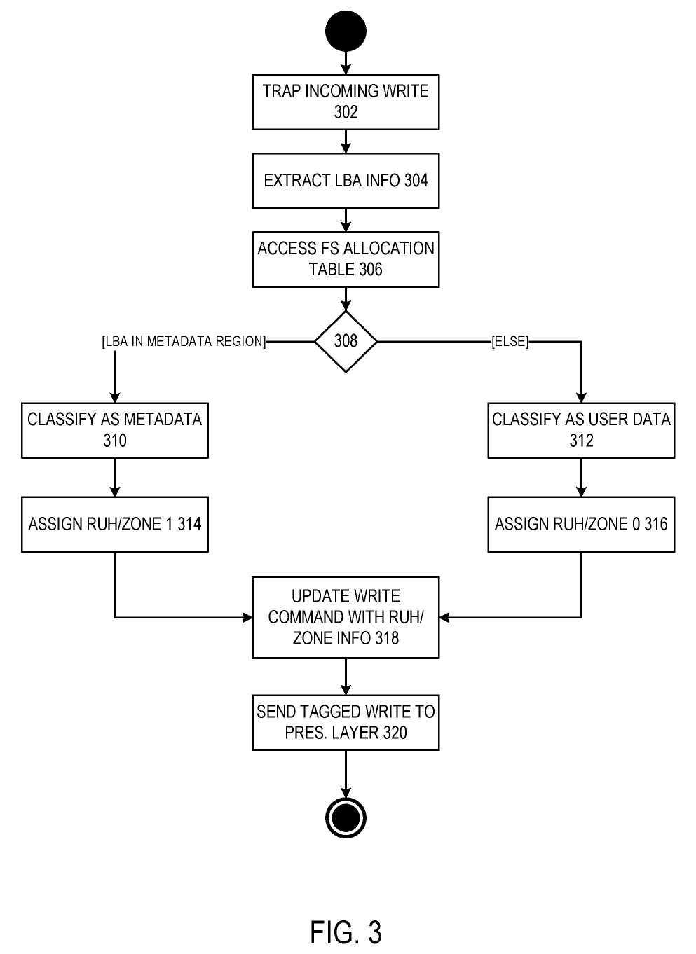

FIG. 3 is a flow diagram illustrating a method for performing back queries specifically for file system data classification according to some of the disclosed embodiments.

The method starts at step 302, where the method traps an incoming write request from a file system. This trapping mechanism is implemented within the functional layer of the helper routine and focuses specifically on write operations originating from file systems. In some implementations, the trapping is accomplished by registering a callback function with the operating system’s I/O subsystem, allowing the helper routine to intercept write requests before they reach the block I/O layer. This interception is transparent to the file system, which continues to operate as if it were communicating directly with the block layer, ensuring compatibility with existing file system implementations.

In step 304, the method extracts Logical Block Address (LBA) information from the write request. The LBA specifies the logical location where the file system intends to write the data. This address will be used to determine the nature of the data being written. In some implementations, the LBA extraction involves parsing the I/O request structure provided by the operating system, which typically includes fields for the starting LBA and the number of blocks to be written. The method captures both the starting address and the range to enable accurate classification of the entire write operation.

In step 306, the method accesses the file system’s allocation table. The allocation table is a data structure maintained by the file system that maps logical blocks to files and file metadata. Different file systems implement their allocation tables in various ways—for example, ext4 uses an inode table and block groups, NTFS uses a Master File Table (MFT), and XFS uses B+ trees. Despite these differences, all file systems maintain some form of mapping between logical blocks and the data they contain. The method accesses these structures using standard operating system interfaces or file system-specific APIs, allowing it to determine the purpose of the blocks being written without requiring modifications to the file system code.

In step 308, the method examines whether the LBA is located in a metadata region of the file system. This decision point represents a classification step that will determine how the data is handled by the storage system. The determination is made based on the information obtained from the file system’s allocation table in the previous step. In some implementations, the method might check if the LBA corresponds to blocks allocated for directory entries, file attributes, journaling information, or other structural elements of the file system. The exact criteria for identifying metadata regions vary depending on the file system type, and the method adapts its approach accordingly.

If the LBA is determined to be in a metadata region, the method proceeds to step 310, where it classifies the data as metadata. File system metadata includes structural information such as directory hierarchies, file attributes, access control lists, journaling records, and other housekeeping data. Metadata typically has different characteristics than user data—it is usually smaller in size, updated more frequently, and its integrity is for the overall file system health. Correctly identifying metadata allows the storage system to place it optimally for both performance and reliability.

If the LBA is not in a metadata region, the method proceeds to step 312, where it classifies the data as user data. User data represents the actual contents of files stored within the file system. This data varies widely in size, access patterns, and importance depending on the specific files and applications involved. By distinguishing user data from metadata, the storage system can apply different placement and management policies appropriate for each type.

After classification, the method proceeds to assign an appropriate RUH or Zone based on the data type. If the data was classified as metadata in step 310, the method proceeds to step 314, where it assigns RUH 1 or Zone 1 to the write request. This assignment typically directs metadata to a high-performance, high-endurance storage region optimized for frequent, small writes. In some implementations, RUH 1 or Zone 1 might correspond to storage areas with SLC flash memory, which offers superior write endurance and performance compared to denser flash technologies.

If the data was classified as user data in step 312, the method proceeds to step 316, where it assigns RUH 0 or Zone 0 to the write request. This assignment typically directs user data to storage regions optimized for capacity and sequential access patterns. In some implementations, RUH 0 or Zone 0 might correspond to storage areas with TLC or QLC flash memory, which offers higher density at the cost of lower write endurance and performance—a trade-off that is often acceptable for user data that is written less frequently than metadata.

After the appropriate RUH or Zone has been assigned, both paths converge at step 318, where the method updates the write command with the RUH or Zone information. This update involves modifying the command structure to include the assigned RUH or Zone identifier in the appropriate field. In some implementations, this might involve setting specific bits in the command descriptor block for NVMe commands, adding extension fields to SCSI (Small Computer System Interface) commands, or utilizing vendor-specific command extensions depending on the storage interface being used. The modification is performed in a way that is compatible with the storage device’s command protocol, ensuring that the device can correctly interpret the placement directive.

In step 320, the method sends the tagged write to the presentation layer. The presentation layer is responsible for mapping the logical storage view to the physical devices and will use the RUH or Zone information to direct the write to the appropriate storage location. This handoff represents the completion of the functional layer’s responsibility for this write request. The presentation layer will handle the subsequent steps of translating the logical address to a physical location and issuing the appropriate commands to the storage device.

The method then can end, completing the file system-specific back query and classification process for this write request. This specialized flow provides optimized handling for file system writes, which typically represent a significant portion of the I/O workload in most computing systems.

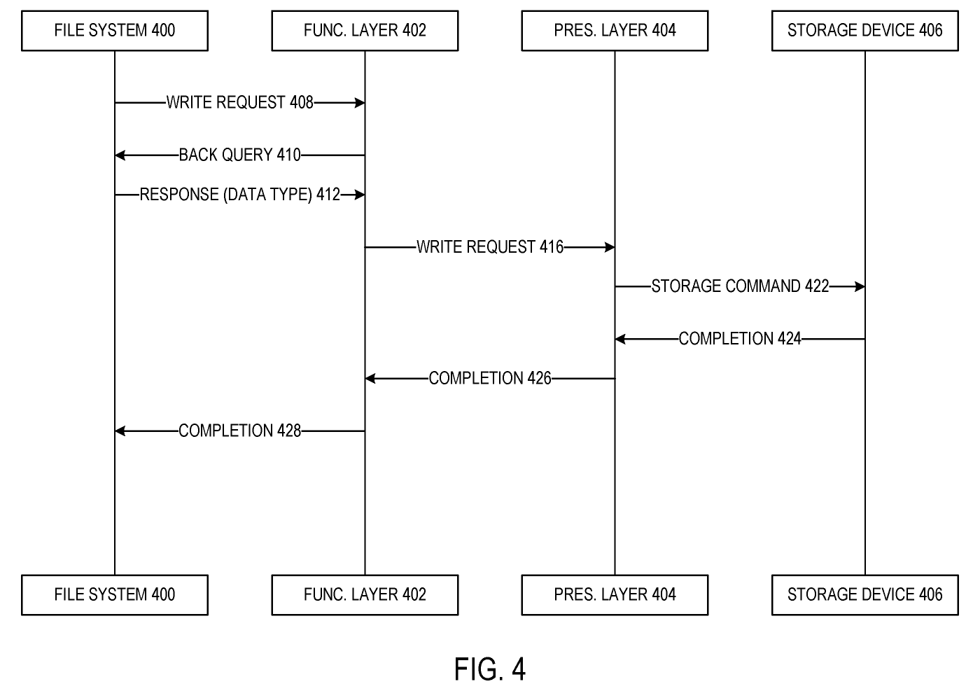

FIG. 4 is a sequence diagram illustrating the interaction between components during a write operation with back query according to some of the disclosed embodiments.

The sequence begins with the file system 400 sending a write request (message 408) to the functional layer 402. This write request contains the LBA where the file system intends to write data. In typical operating systems, file systems issue write requests when applications need to persist data to storage. These requests specify the logical location where the data should be stored, without concern for the physical storage layout. The write request is a standard I/O operation that would normally proceed directly to the block I/O subsystem, but in this architecture, it is intercepted by the Functional Layer.

Upon receiving the write request, the functional layer 402 is activated. This activation represents the beginning of the functional layer’s processing for this particular write operation. The functional layer’s primary responsibility at this stage is to determine the nature of the data being written so that it can be appropriately tagged for optimal placement on the storage device.

To determine the data type, the functional layer issues a back query (message 410) to the file system 400. This back query includes the LBA from the original write request and represents one improvement in the disclosed method. Unlike traditional storage stacks where data flows primarily downward from file systems to storage devices, this back query establishes a two-way communication channel that allows the functional layer to obtain contextual information about the data being written. The back query is implemented through kernel interfaces that allow the functional layer to access the file system’s internal structures.

The file system 400 processes the back query by examining its allocation tables and metadata to determine whether the specified LBA corresponds to file system metadata or user data. After this analysis, the file system sends a response (message 412) back to the functional layer 402. This response indicates the data type associated with the LBA, categorizing it as either metadata or user data. The file system performs this analysis using its internal knowledge of how it has organized its logical address space, without requiring any modifications to its core code.

Upon receiving the response, the functional layer 402 makes a decision based on the data type information. This branching logic allows the functional layer to handle metadata and user data differently, optimizing their storage placement according to their distinct characteristics and requirements.

If the response indicates that the data is metadata, the functional layer follows the first branch and sends a modified write request (message 416) to the presentation layer 404. This modified write request includes both the original LBA and a RUH value of 1. The RUH value of 1 is a tag that directs the storage system to place this metadata in a region optimized for metadata characteristics—typically a high-performance, high-endurance area of the storage device. File system metadata is important for system integrity and is often accessed frequently in small, random patterns, making it a good candidate for placement in premium storage regions.

Alternatively, if the response indicates that the data is user data, the functional layer follows the second branch and sends a modified write request (message 416) to the presentation layer 404. This write request includes the original LBA and an RUH value of 0. The RUH value of 0 directs the storage system to place the user data in a region optimized for user data characteristics—typically a higher-capacity, possibly lower-performance area of the storage device that is better suited for larger, sequential access patterns common with user data.

After sending the modified write request to the presentation layer, the functional layer’s immediate responsibilities for this operation are complete, and it is deactivated. The processing responsibility now shifts to the presentation layer.

The presentation layer 404 is activated upon receiving the modified write request. This activation represents the beginning of the presentation layer’s processing for this write operation. The presentation layer’s primary responsibility is to translate the logical storage view into physical storage operations, taking into account the RUH information provided by the functional layer.

The presentation layer processes the request and formulates a storage command that incorporates the RUH information. It then sends this command (message 422) to the storage device 406. This storage command is device-specific and includes both the data to be written and the placement information derived from the RUH value. The command instructs the storage device to place the data in a specific reclaim unit or zone that aligns with its classification as either metadata or user data.

The storage device 406 executes the write operation according to the command, placing the data in the specified reclaim unit or zone. After completing the write operation, the storage device sends a completion message (message 424) back to the presentation layer 404. This completion message indicates that the data has been successfully written to the storage media in the specified location.

Upon receiving the completion message, the presentation layer 404 forwards a completion notification (message 426) to the functional layer 402. This notification indicates that the write operation has been successfully executed according to the specified parameters. After sending this notification, the presentation layer’s responsibilities for this operation are complete, and it is deactivated as shown by the end of its activation bar.

Finally, the functional layer 402 forwards the completion notification (message 428) to the file system 400. This completes the full cycle of the write operation, from the initial request to the final acknowledgment of completion. From the file system’s perspective, the write operation has been processed normally, with no indication of the additional classification and placement optimization that occurred behind the scenes.

The sequence diagram illustrates the non-invasive nature of the disclosed method. The file system interacts with the storage stack in the standard manner, issuing write requests and receiving completion notifications as it would in a conventional system. The back query, data classification, and optimized placement all occur transparently, without requiring any modifications to the file system’s code or behavior. This transparency is an advantage of the approach, enabling advanced storage optimizations while maintaining compatibility with existing software ecosystems.

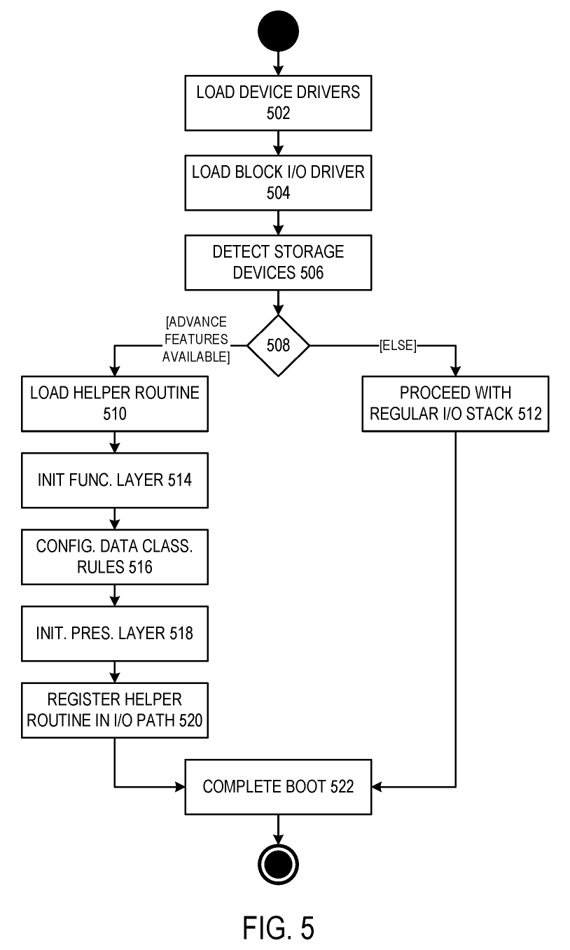

FIG. 5 is a flow diagram illustrating a method for initializing the helper routine during system boot according to some of the disclosed embodiments.

In some implementations, the method begins at system boot. System boot encompasses the sequence of operations that occur when a computing system is powered on or restarted. This includes hardware initialization, firmware execution, and the loading of the operating system kernel into memory. The boot process establishes the foundation upon which all subsequent system operations will run, including the storage subsystem that is the focus of this method.

In step 502, the method loads device drivers as part of the operating system initialization. Device drivers are specialized software components that enable the operating system to communicate with and control hardware devices. The loading sequence typically follows a predetermined order based on dependencies between drivers and the system’s hardware discovery process. Storage device drivers are particularly as they enable access to the system’s boot volume and other storage media that may contain essential system files.

In step 504, the method specifically loads the block I/O driver. The block I/O driver is a fundamental component of the storage stack that provides a standardized interface for block-level operations across various storage device types. It abstracts away device-specific details, allowing higher-level components to interact with storage using a consistent set of operations such as read, write, and flush. The block I/O driver serves as the foundation upon which more specialized storage functionality can be built.

In step 506, the method detects the storage devices connected to the system. This detection process involves querying hardware buses (such as SATA, NVMe, or SAS) for attached devices, initializing communication with these devices, and gathering information about their capabilities. The system identifies not only the presence of storage devices but also their specific features, capacities, and supported command sets. This information is important for determining whether advanced storage features can be utilized.

In step 508, the method evaluates whether advanced storage features are available on the detected devices. This decision point represents a juncture in the initialization flow. The method checks whether the storage devices support technologies such as FDP with RUH, ZNS, or heterogeneous cell types (SLC/QLC partitions). This evaluation may involve sending capability inquiry commands to the devices and analyzing their responses, or checking device identification information against a database of known device capabilities.

If advanced storage features are available, the method proceeds to step 510, where it loads the helper routine. The helper routine is a specialized software component designed to enable intelligent data placement without requiring modifications to existing file systems or applications. Loading the helper routine involves allocating memory for its code and data structures, initializing its internal state, and establishing connections with other components of the storage stack. The helper routine is loaded as an optional enhancement to the standard storage stack, allowing it to be bypassed or disabled if necessary without compromising basic storage functionality.

If advanced storage features are not available, the method takes the alternative path to step 512, where it proceeds with the regular I/O stack. The regular I/O stack represents the conventional storage path without the enhanced data placement capabilities. This ensures that the system remains functional even when connected to storage devices that do not support advanced features. The regular I/O stack provides standard block-level access to storage devices, allowing file systems and applications to operate normally, albeit without the performance and endurance benefits of optimized data placement.

Following the loading of the helper routine in step 510, the method proceeds to step 514, where it initializes the functional layer. The functional layer is responsible for intercepting I/O requests, determining the nature of the data being written, and tagging the requests accordingly. Initialization of this layer involves setting up interception hooks in the I/O path, allocating memory for its data structures, and establishing communication channels with the components it will interact with, particularly the file systems and other storage abstraction layers that will be sources of I/O requests.

In step 516, the method configures data classification rules. These rules define how different types of data will be identified and categorized. Configuration may involve loading rule sets from persistent storage, applying default rules based on detected storage devices, or dynamically generating rules based on system characteristics. The classification rules cover various scenarios including file system data vs. metadata, key-value store keys vs. values, database tables vs. logs, and other application-specific data types. These rules are central to the helper routine’s ability to make intelligent data placement decisions.

In step 518, the method initializes the presentation layer. The presentation layer is responsible for mapping the logical storage view to physical devices and directing tagged I/O requests to appropriate storage locations. Initialization of this layer includes setting up device mapping tables, loading or creating configuration for how logical addresses map to physical devices, and establishing the mechanisms for translating between the logical view seen by upper layers and the physical layout of the storage devices. The presentation layer must be aware of the specific capabilities of each storage device to properly utilize their advanced features.

In step 520, the method registers the helper routine in the I/O path. Registration involves inserting the helper routine’s components at the appropriate points in the storage stack to intercept and process I/O requests. This typically means placing the functional layer between the virtual file system and the block I/O driver, and positioning the presentation layer between the functional layer and the device-specific drivers. The registration process establishes the data flow paths that will be used during normal system operation, ensuring that I/O requests are properly intercepted, classified, and directed.

Both step 512 (proceeding with regular I/O stack) and step 520 (registering helper routine in I/O path) converge at step 522, where the method completes the boot process. Completing the boot process involves finalizing the initialization of all system components, transitioning from boot-time code to runtime operation, and making the system available for user interaction. At this point, the storage subsystem is fully operational and ready to process I/O requests, either through the enhanced path provided by the helper routine or through the standard I/O stack, depending on the availability of advanced storage features.

The initialization flow illustrated in FIG. 5 demonstrates the non-invasive nature of the helper routine. By loading and configuring the helper routine only when advanced storage features are available, and providing a fallback to the regular I/O stack when they are not, the method ensures compatibility across a wide range of system configurations while enabling performance and endurance optimizations when possible.

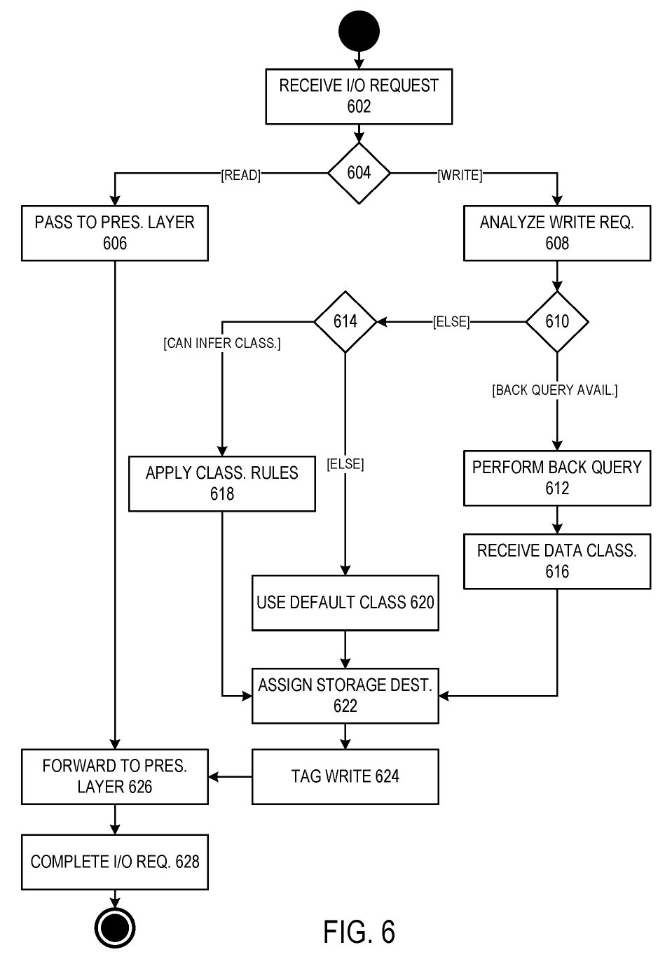

FIG. 6 is a flow diagram illustrating a method for handling I/O requests with data classification according to some of the disclosed embodiments.

The method begins at step 602, where an I/O request is received by the functional layer. This I/O request originates from a higher layer in the storage stack, such as the virtual file system, and may represent various storage operations initiated by applications or system processes. The functional layer intercepts this request as part of its role in the helper routine, examining it to determine the appropriate processing path.

In step 604, the method branches based on the operation type of the I/O request. This decision point differentiates between read and write operations, which require different handling in the context of data classification and placement. The operation type is determined by examining the command field or operation code within the I/O request structure, which indicates whether data is being retrieved from or sent to storage.

If the operation is a read request, the method proceeds to step 606, where it passes the request through to the presentation layer without modification. Read operations do not require classification because they do not change the data layout on the storage device. The placement of data has already been determined during previous write operations, and the storage system needs only to retrieve the data from its current location. By passing read requests directly to the presentation layer, the method minimizes processing overhead for these operations, ensuring optimal read performance.

If the operation is a write request, the method proceeds to step 608, where it analyzes the write request in more detail. This analysis involves examining the request parameters, such as the LBA, transfer size, and any associated metadata or flags. The goal of this analysis is to gather sufficient information to determine the appropriate classification for the data being written, which will influence its placement on the storage device.

After analyzing the write request, the method proceeds to step 610, where it determines whether a back query is available for this particular write operation. This decision point addresses the reality that back queries may not be possible or practical for all originators of write requests. The availability of a back query depends on factors such as whether the originator has a queryable interface, whether the functional layer has been configured with knowledge of how to query this specific originator, and whether the system state permits such queries at the current time.

If a back query is available, the method proceeds to step 612, where it performs a back query to the originator of the write request. This back query is a direct communication with the component that generated the write request, such as a file system, key-value store, or database. The query typically includes the logical address being written and requests information about the nature of the data at that address. The implementation of this query varies depending on the type of originator, but it generally leverages existing interfaces or extension points in the originator’s code.

After performing the back query, the method proceeds to step 616, where it receives the data classification from the originator. This classification represents authoritative information about the nature of the data being written, such as whether it is file system metadata or user data, a database index or log, or a key or value in a key-value store. The classification is based on the originator’s internal knowledge of its data structures and can be highly specific and accurate.

If a back query is not available, the method follows the right branch to step 614, where it determines whether the classification can be inferred from other information. This decision point addresses situations where direct querying of the originator is not possible but alternative methods of classification might still be effective. The ability to infer classification depends on factors such as recognizable patterns in the write request, historical access patterns for the logical address range, or other heuristics that correlate with data types.

If classification can be inferred, the method proceeds to step 618, where it applies classification rules to determine the data type. These rules might consider factors such as the size of the write, the logical address range, frequency of updates to this address range, or other heuristics. The rules are typically configurable, allowing system administrators to tune the classification behavior based on their knowledge of the workloads running on the system.

If classification cannot be inferred, the method proceeds to step 620, where it uses a default classification for the data. This default classification represents a conservative approach that ensures all data is handled in a functionally correct manner, even if not optimally placed. The default might be to treat all data as general-purpose user data, or it might vary based on system-wide policies or configuration settings.

The paths from step 616, step 618, and step 620 converge at step 622, where the method assigns a storage destination based on the determined classification. This assignment maps the data classification to specific storage regions, such as reclaim units or zones, that are optimized for that type of data. For example, frequently updated metadata might be assigned to high-endurance storage regions, while rarely accessed user data might be assigned to high-capacity, lower-endurance regions.

After assigning the storage destination, the method proceeds to step 624, where it tags the write request with the appropriate RUH or Zone information. This tagging modifies the write command structure to include fields that direct the storage device to place the data in the specified region. The exact format of this tag depends on the command protocol used by the storage device, but it typically utilizes reserved fields or vendor-specific extensions in the command structure.

In step 626, the method forwards the processed I/O request to the presentation layer. This step represents the handoff between the functional layer and the presentation layer within the helper routine. At this point, read requests that were passed through in step 606 and write requests that have been analyzed and tagged converge on the same path. The presentation layer will handle the subsequent steps of translating the logical view of storage to the physical devices and issuing the appropriate commands.

Finally, in step 628, the method completes the I/O request from the perspective of the functional layer. This completion may involve updating internal statistics, logging relevant information for debugging or performance analysis, and preparing for the next I/O request. The actual storage operation will continue to be processed by the presentation layer and ultimately by the storage device, but the functional layer’s role in classification and tagging is now complete.

The flow diagram illustrated in FIG. 6 demonstrates the method’s flexible approach to handling different types of I/O requests and data classifications. By providing multiple paths for determining data classification—direct back queries, inference based on rules, and default classifications—the method can adapt to a wide variety of storage workloads and system configurations while maintaining optimal data placement whenever possible.

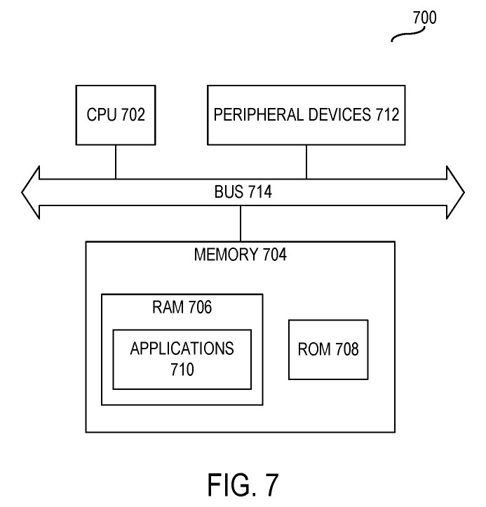

FIG. 7 is a block diagram of a computing device according to some embodiments of the disclosure.

As illustrated, the device 700 includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 702 may comprise a general-purpose processor. The CPU 702 may comprise a single-core or multiple-core processor. The CPU 702 may comprise a system-on-a-chip (SoC) processor or a similar embedded system or processor. In some embodiments, a graphics processing unit (GPU) may be used in place of, or in combination with, a CPU 702. Memory 704 may comprise a memory system including a dynamic random-access memory (DRAM), static random-access memory (SRAM), Flash (e.g., NAND Flash), or combinations thereof. In one embodiment, the bus 714 may comprise a Peripheral Component Interconnect Express (PCIe) bus. In some embodiments, the bus 714 may comprise multiple busses instead of a single bus.

Memory 704 illustrates an example of a non-transitory computer storage media for the storage of information such as computer-readable instructions, data structures, program modules, or other data. Memory 704 can store a basic input/output system (BIOS) in read-only memory (ROM), such as ROM 708 for controlling the low-level operation of the device. The memory can also store an operating system in random-access memory (RAM) for controlling the operation of the device.

Applications 710 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 706 by a processor, such as CPU 702. The CPU 702 may then read the software or data from RAM 706, process them, and store them in RAM 706 again.

The device may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth®, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 7, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
intercepting, by a processor, a write request from a storage abstraction layer;
identifying, by the processor, an originator type of the write request;
performing, by the processor, a back query to the originator to determine a classification of data associated with the write request;
tagging, by the processor, the write request with placement information based on the determined classification;
forwarding, by the processor, the tagged write request to a presentation layer; and
directing, by the presentation layer, the write request to a location on a storage device based on the placement information.

2. The method of claim 1, wherein performing the back query comprises extracting logical block address (LBA) information from the write request, accessing an allocation table of a file system when the originator type is a file system, and determining whether the LBA corresponds to a metadata region or a user data region.

3. The method of claim 1, wherein the placement information comprises at least one of a Reclaim Unit Handle (RUH) for a storage device supporting Flexible Data Placement (FDP) or a Zone identifier for a storage device supporting Zoned Namespace (ZNS).

4. The method of claim 1, wherein performing the back query comprises accessing an internal structure of a key-value store when the originator type is a key-value store, and determining whether the data corresponds to a key or a value.

5. The method of claim 1, wherein performing the back query comprises accessing an internal structure of a database when the originator type is a database, and determining whether the data corresponds to a sorted string table (SST), a write-ahead log, or other database-specific structure.

6. The method of claim 1, further comprising determining that a back query is not available, determining whether a classification can be inferred based on characteristics of the write request, and applying classification rules or using a default classification.

7. The method of claim 1, further comprising initializing a helper routine during a system boot process, the initializing comprising detecting storage devices connected to a computing system, determining whether the connected storage devices support advanced storage features, and loading the helper routine when advanced storage features are supported.

8. A method comprising:
detecting, by a processor, storage devices connected to a computing system;
determining, by the processor, whether the connected storage devices support advanced storage features;
loading, by the processor, a helper routine when advanced storage features are supported;
configuring, by the processor, data classification rules for a functional layer of the helper routine;
initializing, by the processor, a presentation layer of the helper routine; and
registering, by the processor, the helper routine in an I/O path of an operating system.

9. The method of claim 8, wherein determining whether the connected storage devices support advanced storage features comprises querying each storage device for support of at least one of Flexible Data Placement (FDP), Zoned Namespace (ZNS), or heterogeneous cell type partitions.

10. The method of claim 8, wherein configuring data classification rules comprises loading rule sets from persistent storage, applying default rules based on detected storage devices, or dynamically generating rules based on system characteristics.

11. The method of claim 8, wherein initializing the presentation layer comprises setting up device mapping tables and creating configurations for mapping logical addresses to physical devices.

12. The method of claim 8, wherein registering the helper routine comprises positioning the functional layer between a virtual file system and a block I/O driver, and positioning the presentation layer between the functional layer and device-specific drivers.

13. The method of claim 8, further comprising proceeding with a regular I/O stack when the connected storage devices do not support advanced storage features.

14. A method comprising:
receiving, by a processor, an I/O request at a functional layer in a storage stack;
determining, by the processor, whether the I/O request is a read operation or a write operation;
passing, by the processor, the I/O request directly to a presentation layer when the I/O request is a read operation;
analyzing, by the processor, the I/O request when the I/O request is a write operation;
determining, by the processor, a classification for data associated with the write operation; and
assigning, by the processor, a storage destination for the data based on the determined classification.

15. The method of claim 14, wherein determining a classification comprises determining whether a back query is available for an originator of the write operation, performing the back query when available, and receiving a data classification response.

16. The method of claim 14, wherein determining a classification comprises determining that a back query is not available, determining whether classification can be inferred based on characteristics of the write operation, and applying classification rules when inference is possible.

17. The method of claim 14, wherein determining a classification comprises determining that classification cannot be inferred and applying a default classification to the data.

18. The method of claim 14, wherein assigning a storage destination comprises mapping the classification to a specific reclaim unit, zone, or partition optimized for that type of data.

19. The method of claim 14, further comprising tagging the write operation with placement information corresponding to the assigned storage destination.

20. The method of claim 14, further comprising forwarding the I/O request with assigned storage destination information to the presentation layer for mapping to physical storage locations.
